(19) United States
(12) Patent Application Publication
(10) Pub. No.: US 2013/0011820 A1
(43) Pub. Date: Jan. 10, 2013

(54) Device and Method for Evaluating Manual Dexterity

(75) Inventor: Kathleen E. Yancosek, Hopkinton, MA (US)

(73) Assignee: Government of the United States, as represented by the Secretary of Army, Fort Detrick, MD (US)

(21) Appl. No.: 13/540,895

(22) Filed: Jul. 3, 2012

Related U.S. Application Data
(60) Provisional application No. 61/505,424, filed on Jul. 7, 2011.

(51) Int. Cl. G09B 19/00

(52) U.S. Cl. 434/258

(57) ABSTRACT

A device for measuring the manual dexterity of a subject comprising a central processing unit, a display, storage means, data-entry means and software programming designed to gather the manual dexterity data of a subject is disclosed together with methods of use thereof.

### RELATED APPLICATIONS

This application claims the benefit of U.S. Provisional Application 61/505,424 entitled “Device and Method for Evaluating Manual Dexterity”, filed Jul. 7, 2011.

### GOVERNMENT INTEREST

This invention was made with support from the United States Government, the United States Army Research Institute for Environmental Medicine and; accordingly, the United States Government has certain rights in this invention.

### BACKGROUND OF THE INVENTION

1. Field of the Invention

The present invention relates to manual dexterity assessment in general, and in particular to devices for measuring manual dexterity and methods of use thereof.

2. Background of the Invention

Due to the structural and functional complexity of the human hand, dexterity has been an elusive construct for scientists to define. The complexities magnified by the embedded cognitive (problem-solving, planning, and attending) and sensory (vision, tactile, and proprioception) components of dexterity. Dexterity is most frequently measured by the time it takes a person to move small objects, generally pegs of various sizes, from one space to another. These type of assessments were developed after World War I and World War II to assess of veteran's ability to be gainfully employed in factory work or other manual labor. These traditional dexterity assessments (e.g., pegboards) were designed to measure “factory work performance” for manual tasks, and do not capture relevant and current demands of hand use, specifically thumb use. Although these assessments are still commonly used today, a recent systematic review of evaluation tools used in hand therapy (Schoneveld, Wittink, & Takken, 2009) concluded that there is a need for more performance assessments that measure activity and participation. Changing occupational and social activities for veterans and civilians alike have moved the need for dexterity assessment beyond measuring the potential for gainful employment in one industrial sector. Furthermore, all current dexterity assessments are limited in scope and depth of information they provide (Bicchi, 2000).

Dexterity assessments are particularly relevant in the military context because of the widespread use of handheld digital technologies across the modern battlefield. Given current operational demands and the high number of neuromusculoskeletal injuries that impair function of the upper extremity, technology must be developed and applied to assess return to duty status of injured service members.

The present invention addresses these needs, and provides an accurate, non-invasive means for doing so.

### SUMMARY OF THE INVENTION

The present invention is a novel method and device evaluating both the embedded cognitive and sensory components of dexterity by assessing an individual's thumb capability using the modern-day activity of texting. Today's drastic change in dexterity demands of the human hand make a phone-based valuation a more relevant measure given the ubiquitous use of cell phones and electronic devices with keypads; the thumb's traditional service as the stable post for fingers to oppose is now a moving digit executing the task of texting.

The present invention is designed to fill a need to measure a novel type of thumb dexterity used in the popular functional task of sending text messages by a mobile telephone or other mobile or electronic device. One embodiment of the invention will resemble a mobile telephone with the standard cellular phone keypad as well as a “slider” option of another keypad. This specific embodiment of the invention will measure a person's thumb dexterity as specifically needed during the functional activity of texting. This appraisal will measure performance based on accuracy and speed. In one embodiment of this invention the assessment device will visually prompt (by the device screen) the user to text a series of letters using the keypad. Letter sequences will be randomly generated based on a difficulty level related to thumb range of motion patterns. After a series of trials, the device will provide a performance summary score for the occupational or physical therapist (or other medical personnel) to record for the person who completed the texting assessment. The device of the present invention will measure, by way of example, performance based on accuracy, speed, and thumb pressure.

There are several advantages of this form of dexterity assessment over the currently available in traditional dexterity assessments:

(1) Texting is a novel form of dexterity in that the thumb is a mobile, rather than the stationary, digit. This is not captured in traditional dexterity assessments.
(2) There are neuromusculoskeletal conditions that affect the thumb and hand that could be better tested with this device as opposed to the currently available assessment. Examples of these conditions include: Blackberry Thumb, DeQuervain's tenosynovitis, carpometacarpal arthritis, and digital stenosing tenosynovitis.
(3) The precision and resolution of analysis provided by the various embodiments of the present invention will far exceed those traditional assessments requiring manual measurements, visual observation and human supervision.

A method of evaluating the manual dexterity of a subject is disclosed comprising the steps of:

a) Determining the subject's manual data-entry skill;
b) Gathering data on the subject's manual dexterity using at least one manual data-entry test;
c) Storing the data on computer readable media; and,
d) Calculating a manual dexterity performance metric utilizing the stored data.

Also disclosed is a device for measuring the manual dexterity of a subject comprising a central processing unit, a display, storage means, data-entry means and software programming designed to gather the manual dexterity data of a subject.

Other and further aspects, objects, features, and advantages of the present invention will be apparent from the description of the invention set forth herein.

### BRIEF DESCRIPTION OF THE DRAWINGS

FIG. 1 is a drawing of the preferred embodiment of the device invention.

FIG. 2 is a drawing of an alternative embodiment of the device invention.

FIG. 3 is a diagram showing the process flow of an embodiment of the method invention.

FIG. 4 is a flow chart diagram showing one embodiment of the system invention.

FIG. 5 is a pictorial block diagram of a configuration of one embodiment of the device of the present invention.

### DETAILED DESCRIPTION OF ILLUSTRATIVE EMBODIMENTS

In order to provide a clear and consistent understanding of the specification and claims, including the scope to be given such terms, the following definitions are provided.

### DEFINITIONS

As used herein, “communication means” refers to means for conveying digital information, synchronously and asynchronously, as an electromagnetic signal from one electronic device to another, to include without limitation: Universal Serial Bus (USB) ports, FIREWIRE™, wired technology, optical fiber, wireless (including BLUETOOTH™, ANT+™), analog-to-digital conversion (e.g. through a microphone), cellular, microwave, satellite, infrared, Large Area Networks, Local Area Networks, Internet/Web, and radio.

The term “data-entry means” refers to any device for accepting data from a subject, to include without limitation: keyboards, keypads, touchpads, tactile sensors, capacitive sensing devices, and conductance sensing devices, regardless of whether the data entry means requires the use of a stylus or similar writing implements.

In many configurations, a computer or computer device will comprise at least a readable and writable memory, read-only memory or non-volatile memory of a suitable type, and a processor (e.g., a central processing unit or CPU) which may itself comprise one or more microprocessor, co-processors, etc. Thus, the term, “processor,” as used herein, is not literally restricted to a single CPU. Moreover, a computer or computer device may itself comprise a network of one or more computers, as can any other device referred to as a “computer” or “computer device” herein.

In some configurations, the systems, methods and devices described herein may feature a graphical user interface (GUI) which may include standard GUI elements such as windows, dialog boxes, menus, drop-down lists, radio-buttons, check boxes, icons, etc.; and provides functionality to define and express parameter input and output display options, through inputs such as mouse movements and mouse clicks. User interaction with the interface is achieved by one or more methods that may include, for example, pointing and clicking with the mouse, touchpad, or other input device, or typing on a keyboard, or speaking into a microphone and using voice command recognition software. In some configurations, subject manual dexterity data, normative data, parameter inputs, display options, etc. (comprehensively referenced herein as Data) are imported, either in part or in their entirety, from all-text representations, examples of which include, but are not limited to, XML-based documents. Some configurations allow imported Data to be edited and modified, stored in a memory of the server computer or elsewhere, and/or re-exported in their original formats and/or other formats.

The terms “display” and “accept” as used in the description herein referred to a suitably programmed computing apparatus “displaying” or “accepting” data, not to a person “displaying” or “accepting” something. A person might, however view the display data on an output device on a page produced by an output device or supplied except the data using an input device.

As used herein, software instructions are said to “instruct the computer to display” information even if such information is communicated via a network to another computer for display on a remote display terminal. In this sense code running on a Web server instructs a processor executing that code to “display” a webpage, even though the code actually instructs the processor to communicate data via a network that allows a browser program to instruct in other computer to construct the display of the webpage on the display of the other computer. For example, the server module described in the examples presented herein can include a Web server and the client modules can comprise Web browsers

“manual data-entry” means any method of entering data into a computerized system that requires mechanical manipulation of a subject's hand and/or arm, whether or not that subject's hand or arm is assisted with orthotics or comprises of a prostheses.

Machine-readable or computer readable medium or media may compromise, for example, one or more floppy diskette's, CD-ROMs, CD-RWs, DVDs, DVD-Rs, DVD-RWs, memory devices such a USB memory sticks or other types of memory cards, internal readable and writable memory of any of various kinds, such as internal or external RAM, read only memory (ROM) of any of various kinds, hard disks optical drives, and combinations thereof. As used herein, “media” includes not only “removable” media, but also “non-removable” media such as primary and secondary storage. For example, RAM, ROM, and hard disk drives are included as “media,” as well as the aforementioned types of media.

By “neuromusculoskeletal” I mean any disease or impairment that affects the nervous system, brain, spinal cord, nerves, as well as muscles, bones, cartilage, and joints of a subject's body.

The difficulty of a sentence or key combination can be determined in a number of ways know in the art. For instance, difficulty of a sentence or key combination can be evaluated beforehand using physiological, subjective, and objective performance measures such as surveys of perceived difficulty stratified by a demographic category like age or education level. Alternatively, or in addition to subjective or psychological models, a formal determination of sentence or key combination difficulty can be attained through the use models used to evaluate the predictive behavior of the user such, by way of non-limiting example, the Fitts' law, GOMS and Hick-Hyman models and adapted or modified versions of the models thereof (Vigouroux N., Vella F., Truillet P. & Raynal M. (2004). However, it is understood that various models and techniques for evaluating the difficulty of a particular sentence or key combination are within the scope of this invention.

By way of non-limiting example, difficulty of a sentence or key combination would depend on device size, movement direction, and interaction location. The impact of these factors on user performance is captured by measuring the movement speed as a proxy for task difficulty—the harder the task, the slower the thumb movement.

The population norms for metrics useful in evaluating the difficulty of a sentence or key combination can be determined using known statistical means. The range of each classification for the difficulty of a sentence or a key combination (e.g. for example Easy, Medium, Hard) can be extrapolated from the normal population distribution of measured user performance metrics, or from surveys of perceived difficulty or a combination of both. For instance, by way of example, a key combination that is successfully completed by 75% of a population of users under a specified threshold error rate and time for completion could be classified as “EASY”. Similarly, a key combination that is successfully completed by only 25% of the same population of users under the same specified threshold error rate and time for completion could be classified as “HARD”; with a “MEDIUM” ratting being assigned to the a successful completion rate by 50% of users. As an alternative example, ratings could be classified by correlating thumb movement speed with a specified success rate as described above, with a range of thumb movement speed being assigned to each category: “Hard”, “Medium” and “Easy”. The selection of ranges and thresholds for determining whether a particular sentence or key combination may be classified as “Hard” or “Easy” is subject to variability based on the tasks being performed and the user population being evaluated. What may be “Easy” for a fully-abled user may be “Hard” for persons with disabilities. It is, therefore, understood that various ranges used to classify the difficulty of a particular sentence or key combination are still to be considered within the scope of this invention if

By “soft keyboard” we mean a numerical representation of a physical keyboard (AZERTY, QWERTY, T9 etc.). This representation is comparable to an interactive system having a visual interface containing interaction buttons. They can correspond to one or several alphabet codes (phonemes, latin characters, etc.) or function keys. These function keys could be displayed in any input window by making a direct interation on buttons using a finger or any variation of a pointing device or stylus.

The term “statistical methods” refers to both descriptive and inferential statistics well known in the art, to include without limitation those statistical methods, tests (parametric and non-parametric) and procedures particular to the fields of biostatistics and psychological statistics.

The term “storage means” refers to any means for storing data that is accessible by an electronic digital computer to include, without limitation: volatile memory (RAM, SRAM, DRAM, Z-RAM, TTRAM, A-RAM and ETA RAM) and non-volatile memory (ROM, flash memory, magnetic computer storage devices and optical discs), whether or not the data is stored in a database.

As used herein, the term “subject” means any living organism, including humans, and mammals.

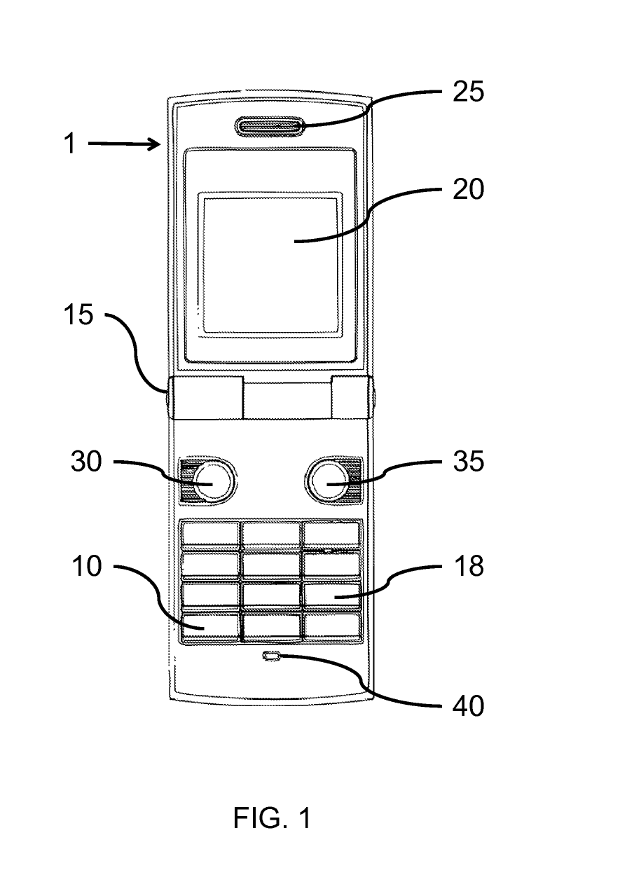

For purposes of clarity of disclosure, and not by way of limitation, the detailed description of the invention is described by way of the demonstrative examples discussed below, and as further described in FIGS. 1-3.

### Example 1

### Manual Thumb Dexterity Measurement Method

In this first non-limiting example, the invention comprises a method for measuring the following variables described in Table 1:

TABLE 1
Variables Assessed

| Speed | Accuracy |
|---|---|
| Time from start | Errors: |
| to send of message | a) Spelling errors |
| | b) Addition of letters |
| | c) Deletion of letters |
| | d) Reversals of letters |
| | e) Use of CLR/BACK/DEL button to |

### Protocol

A. The subject taking the assessment will be asked by the evaluator how frequently they send text messages.

“Please select which statement best describes you”:
“1. I text once a month or less”
“2. I text 3-5 times during a two week period.”
“3. I text every day.”

B. The skill level selected for the assessment will be based on the subject's chosen statement (Response 1=Skill Level I, Response 2=Skill Level II, and Response 3=Skill Level III). (see table 2 below for skill level descriptions).

TABLE 2
Subject Skill Level

| SKILL LEVEL I | SKILL LEVEL II | SKILL LEVEL III |
|---|---|---|
| Easy letter combos and | Moderate letter combos | Difficult letter combos |
| short in length | and short in length | and short in length |
| Easy letter combos | Moderate letter combos | Difficult letter combos |
| and medium in length | and medium in length | and medium in length |
| Easy letter combos | Moderate letter combos | Difficult letter combos |
| and long in length | and long in length | and long in length |

C. The evaluator will instruct the subject to take the assessment:

“We are interested in how quickly and how accurately you can send a text message using a mobile phone. The messages are randomly generated letter combinations based on your experience level with texting. Pick up the phone with only one hand, use the hand you write with. Push the green start button and begin to text the letter combinations you see on the screen. Remember to only use one hand. You will text four messages with your writing hand.”

After the subject completes the dominant hand assessment, the evaluator will say:

“Now please pick up the phone with your other hand. Push the green start button and begin to text the letter combinations you see on the screen. Remember to use only one hand. You will text four messages with this hand”.

After the subject completes the non-dominant hand assessment, the evaluator will say:

“Now please pick up the phone with both hands. Slide the phone apart to reveal the keyboard. Push the green start button and begin to text the letter combinations you see on the screen. You will text four messages. You may use both hands.”

In the preferred embodiment the dexterity evaluation device comprises a test bank of at least 200 text “messages” (letter combinations, not actual words). These messages should be graded within three skill levels based on two characteristics of difficulty (1) letter configurations and (2) length of message according to the parameters described in Table 3.

TABLE 3
Definitions of each difficulty characteristic.

| LETTER COMBINATION | MESSAGE LENGTH |
|---|---|
| Easy: each letter is adjacent within | Short: 30 characters & |
| one button of the next letter; no more | spaces |
| than 2 special characters or numeric symbols | |
| Moderate: each letter is within two | Medium: 60 characters & |
| buttons of the next letter; no more | spaces |
| than 4 special characters or numeric symbols | |
| Difficult: no restrictions on letter, | Long: 90 characters & |
| special characters or numeric symbols | spaces |

D. A composite score is calculated by the following paradigm:

a) The first attempt is a “throw-away” (non-recorded) trial.

b) Average the remaining three attempts together.

c) Total time (in seconds)+Total number of errors=Total Score

d) Calculate a separate Total Score for (1) Right hand, (2) Left hand, and (3) Both hands

e) Present scores by age, gender, difficulty level, and hand dominance.

It can be appreciated by one ordinarily skilled in the art that the order and precise wording of the questions that are asked of a subject may be changed and still be within the scope of the embodiments of the invention as disclosed herein. Further, the definition of the skill levels and the difficulty levels being assessed by this embodiment of the invention may be substantially modified while still remaining within the scope of the preferred embodiment of the invention. Further still, the method of calculating a performance metric from the data gathered by way of this non-limiting example may be modified to suit the specific requirements of the evaluation

### Example 2

### Manual Thumb Dexterity Measurement Device

In another embodiment, the invention comprises a device for measuring the manual dexterity of a subject. The protocol of this example is substantially similar to that of Example 1. Following FIG. 1, the subject (not shown) is given a portable texting device 1 and instructed to turn it on by pressing the appropriate button 10. The device 1 is held in either the right hand or left hand (not shown) depending on which one is dominant or non-dominant. The subject will be instructed to hold the device 1 in such a way that the case 15 is resting comfortably on the palm of the hand (not shown) that is being tested with the keyboard 18 facing outwardly away from the palm and within the visual range of the subject. Those ordinarily skilled in the art would realize that any data-entry means requiring manual manipulation would serve as a suitable substitute for a keyboard and should be considered with the scope of the invention. The device 1 should be positioned in the hand being tested in such a way that the subject's thumb (not shown) can readily manipulate the keyboard 18 in its entirety. In an alternative embodiment, the device 1 may be held in either hand or in both hands in such a way as to allow the manipulation of the keyboard 18 with any finger. Once the device 1 has been activated, the display screen 20 will show a brief introductory message, followed by a general overview of the manual dexterity assessment that the subject is to perform shortly. The information shown on the display screen 20 may be accompanied or substituted with aural instructions conveyed by a speaker 25. The subject will be queried by the device 1 whether he or she has understood the instructions and is ready to proceed. The subject may indicate a “YES” response by pressing the appropriate button 30. Similarly, the subject may indicate a “NO” response by pressing the appropriate button 35. Alternatively, the subject may be able to respond and interact with the device 1 by way of verbal commands relayed through a microphone 40 and processed by a speech recognition software resident within the device's 1 static or volatile memory. It will be appreciated by those ordinarily skilled in the art that the actual method of interacting with the device 1 may vary with the needs of the evaluator, to include various keyboard configurations and input means. Upon initiating the assessment, the device 1 will display a series of questions on the display 20 that will require the subject to enter a response via the keyboard 18 or microphone 40. The survey is designed to assess the subject's perceived level of manual dexterity skill. Alternatively the evaluator may input the subject's skill level without interacting contemporaneously with the subject. The evaluator may obtain information on a particular subject's manual skill level based on previous baselines, observations or evaluations of the subject's manual dexterity. In a third embodiment, the subject's skill level may be automatically programmed into the device 1 by retrieving stored data from volatile or static memory that is resident either on the device 1 itself or retrieved from remote servers or peripheral devices. The device 1 will use the subject's survey data to automatically compile a dexterity performance battery corresponding to a predetermined level of difficulty. The performance metric that results from the assessment will be weighted according to the difficulty level determined as a result of the survey. Once the survey is completed, the manual dexterity performance assessment will commence by displaying sentences of varying length and complexity on the display 20 to the subject. The subject will be instructed to duplicate the displayed data via manual entry using the keyboard 18. The time it takes the subject to perform the task will be recorded by the device and used as part of the calculation of the performance metric. Once the performance test battery has been completed, the subject may be presented with the opportunity to perform one or more additional assessments. The total number of assessments to be performed may be separately configured by the evaluator using the keyboard 18 and display 20. The data obtained from the one or more performance assessments by the device 1 may be stored in static or volatile memory for archival and recall purposes. The device 1 may be programmed to automatically calculate the performance metric utilizing the stored data and it may be equipped with means for the digital transfer of the stored data to peripheral and remote devices via various communications means well known in the art. The performance metric may be displayed instantaneously to the subject or evaluator by way of the display screen 20 or speaker 40, and/or the performance metric may be relayed to a remote device for further evaluation. One ordinarily skilled in the art would recognize that the actual calculation of the performance metric could be performed on the device 1 itself or may actually be calculated on a separate device with communication means to the original texting device 1. The data gathered by this device 1 may be subsequently evaluated and compared to population norms using various statistical algorithms and techniques well known in the art.

### Example 3

### Manual Thumb Dexterity Measurement Device

### QWERTY keyboard

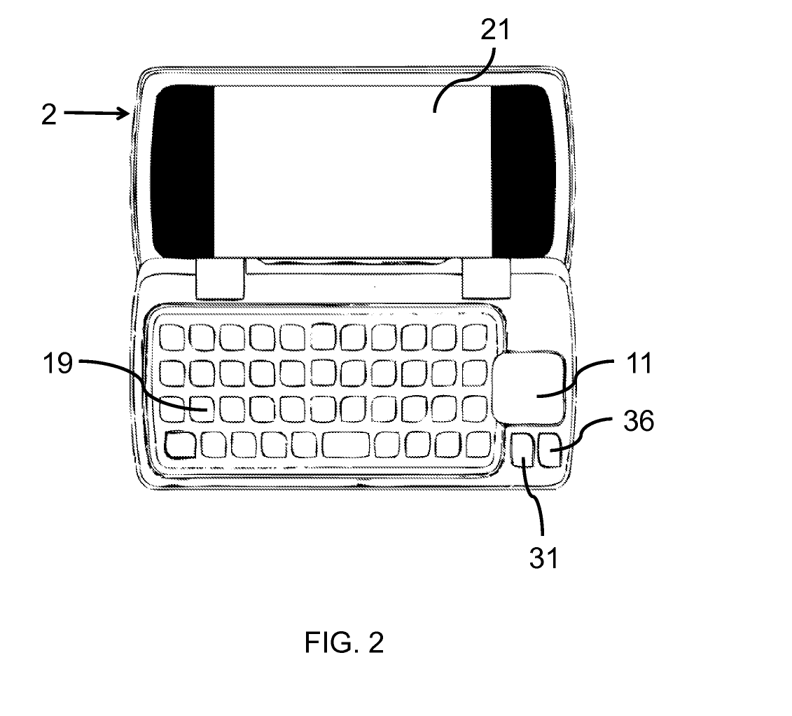

In an alternate embodiment, the invention comprises a device for measuring the manual dexterity of a subject using a QWERTY keyboard. The protocol of this example is substantially similar to that of Example 1 and the features of the device are substantially similar to that of Example 2. Those ordinarily skilled in the art would recognize that any keyboard layout could be substituted for the standard QWERTY layout to suit the needs of the evaluator and that such would be within the scope of this invention. Following FIG. 2, the subject (not shown) is given a portable texting device 2 and instructed to turn it on by pressing the appropriate button 11. Once the device 2 has been activated, the display screen 21 will show a brief introductory message, followed by a general overview of the manual dexterity assessment that the subject is to perform shortly. The subject will be queried by the device 2 whether he or she has understood the instructions and is ready to proceed. The subject may indicate a “YES” response by pressing the appropriate button 31. Similarly, the subject may indicate a “NO” response by pressing the appropriate button 36. Alternatively, the subject may be able to respond and interact with the device 2 by way of verbal commands as described in example 2. It will be appreciated by those ordinarily skilled in the art that the actual method of interacting with the device 2 may vary with the needs of the evaluator, to include various keyboard configurations and input means. Upon initiating the assessment, the device 2 will display a series of questions on the display 21 that will require the subject to enter a response via the QWERTY keyboard 19. Once the survey is completed, the manual dexterity performance assessment will commence by displaying sentences of varying length and complexity on the display 21 to the subject. The subject will be instructed to duplicate the displayed data via manual entry using the QWERTY keyboard 19. The time it takes the subject to perform the task will be recorded by the device and used as part of the calculation of the performance metric. Once the performance test battery has been completed, the subject may be presented with the opportunity to perform one or more additional assessments. As can be appreciated from FIG. 2, this embodiment of the invention is the preferred embodiment for testing the use of both hands of the subject simultaneously, although nothing within this description should serve as a limitation on alternate uses, including the testing of each hand individually. The operation of the embodiment of the invention as shown in FIG. 2 is substantially similar to that of example 2 with respect to storage means, communication means and the development of a performance metric of manual dexterity.

### Example 4

### Manual Thumb Dexterity Measurement System

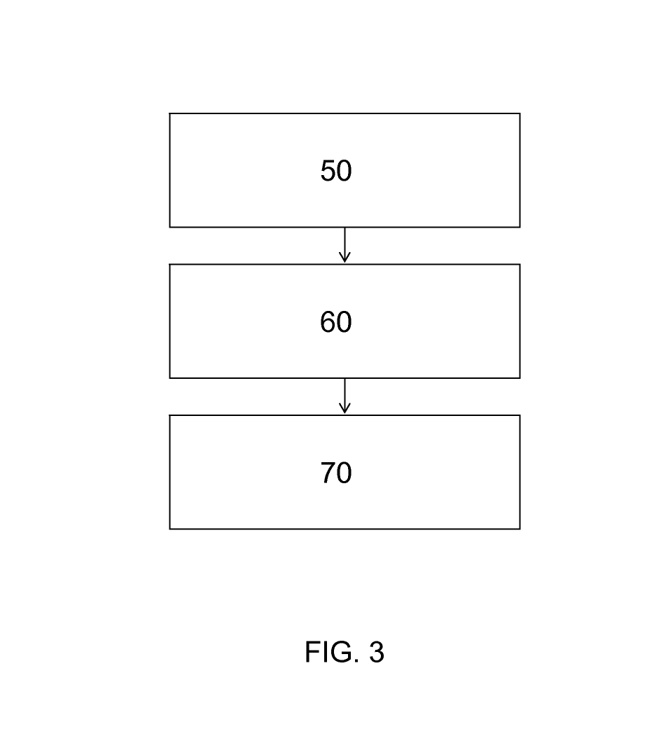

Characteristic of the Applicant's novel device and method is a protocol (see FIG. 3) under which a subject's manual text manipulation skill level is first determined, for example, through a survey or through self reporting 50 and later assessed using a battery of tests that range in varying degrees of difficulty 60, such assessment producing a performance metric 70 which may be useful in diagnosing a disease or medical condition or may be further analyzed by known statistical methods.

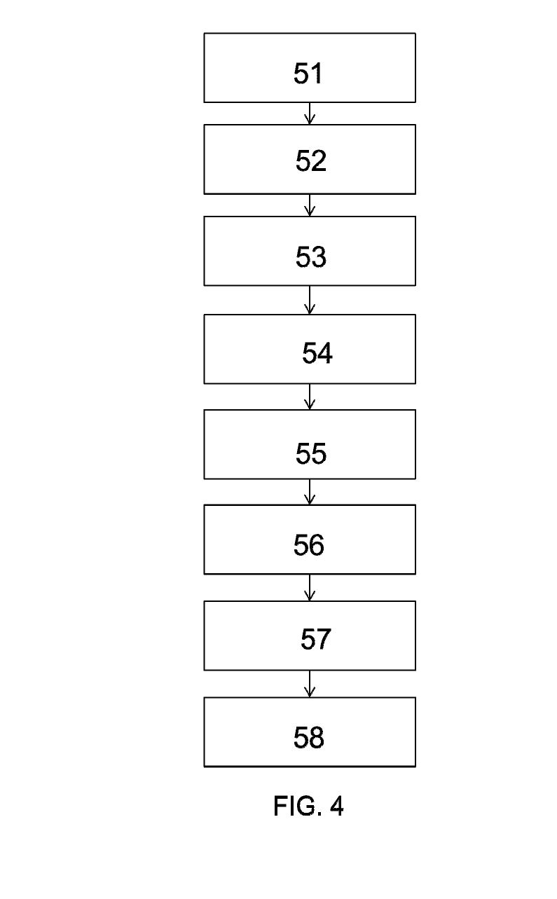

In some configurations of the Applicant's invention and referring to FIG. 4, a system for evaluating manual dexterity includes the steps of: 51 storing in computer readable memory associated with a manual dexterity evaluation system at least one test battery; 52 determining the subject's manual data-entry skill; 53 selecting, via a computer device associated with a manual dexterity evaluation system, at least one manual data-entry test from the at least one test battery based on the subject's manual data-entry skill; 54 instructing the subject on the test procedure; 55 providing via the manual dexterity evaluation system at least one means for inputting data; 56 collecting subject-specific data during the performance of the at least one test by the subject; 57 processing, via the computing device, the subject-specific data to generate at least one manual dexterity performance metric; and, 58 generating, via the computing device, an output including the at least one manual dexterity performance metric. It is understood that, although the preferred sequence of steps in the system for evaluating manual dexterity is described above and in FIG. 4, alterations in the sequence of steps should still be considered within the scope of the invention. For instance, the instructing the subject on the test procedure step 54 may come before the determining the subject's manual data-entry skill step 52. Furthermore, it should also be understood that the system for evaluating manual dexterity can be practiced using fewer than the prescribed steps of the preferred embodiment as shown in FIG. 4, for example, the generating an output step 58 may be omitted from the system and still be considered within the scope of the invention.

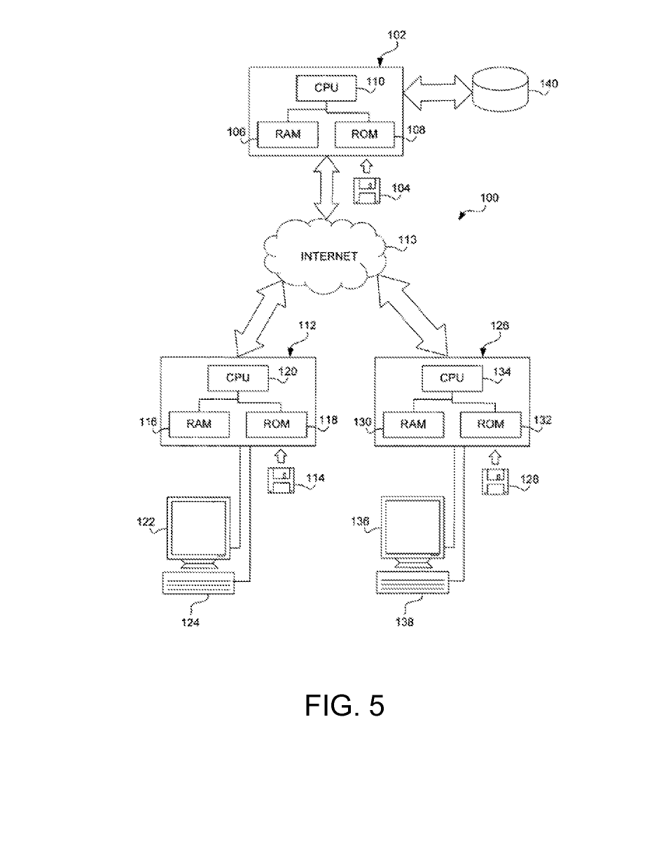

In some configurations of the present invention and referring to FIG. 5, a computer network 100 is configured for providing manual dexterity evaluation. To provide manual dexterity evaluation, some configurations of the present invention are configured to generate outputs, including graphical outputs and patient reports that incorporate such outputs.

In some configurations, computer network 100 comprises a server computer 102 that executes a server module. The server module comprises software instructions recorded on a machine-readable medium or media 104. Machine-readable medium or media may compromise, for example, one or more floppy diskette's, CD-ROMs, CD-RWs, DVDs, DVD-Rs, DVD-RWs, memory devices such a USB memory sticks or other types of memory cards, internal readable and writable memory 106 of any of various kinds, such as internal or external RAM, read only memory (ROM) 108 of any of various kinds, hard disks optical drives, and combinations thereof. As used herein, “media” and “storage means” includes not only “removable” media, but also “non-removable” media such as primary and secondary storage. For example, RAM, ROM, and hard disk drives are included as “media,” as well as the aforementioned types of media. Server computer 102 can include devices for reading removable media, such as CD-ROM drives, a DVD drive, a floppy disk drive, etc. In many configurations, server computer 102 will comprise at least a readable and writable memory 106, read-only memory 108 or non-volatile memory of a suitable type, and a processor 110 (e.g., a central processing unit or CPU) which may itself comprise one or more microprocessor, co-processors, etc. Thus, the term, “processor,” as used herein, is not literally restricted to a single CPU. Moreover, server computer 102 may itself comprise a network of one or more computers, as can any other device referred to as a “computer” herein. Finally, the server computer 102 may retrieve information concerning a subject's manual dexterity by accessing a database 140 that may either reside locally or remotely.

Computer network 100 further comprises one or more first client computers 112. In many configurations, it is in communication with the server computer 102 via a network 113, for example, the Internet. However, the alternate embodiments of this invention are capable of functioning through a variety of known networks, including local area networks (LANs), wide area networks (WANs), virtual private networks (VPNs), cellular networks, near field communications (NFC) networks, and similar networks such as the IEEE Standard 802.15.1-2002 standard BLUETOOTH™ Bluetooth Special Interest Group, Kirkland, Wash. USA network. In many configurations of the present invention, client computer 112 comprises a first client module comprising software instructions recorded on the machine-readable medium or media 114. In many configurations, client computer 112 further comprises at least a readable and writable memory 116, read-only memory 118, and a processor 120 that may itself comprise one or more microprocessors, coprocessors, etc. First client computer 112 may itself comprise one or more computers in a network. First client computer 112 further may comprise a first user display device 122, such as a CRT display, LCD display, plasma display, and/or a hardcopy device such as a printer. First client computer 112 may also comprise a first user input device 124, such as a keyboard, a microphone for accepting voice commands, a mouse, a touchscreen (which may be part of the display 122), and/or a trackball, etc. First client computer 112 is not limited to desktop or laptop computers that can include any computing device that can communicate over a network. For example, in some configurations, a first client computer 112 can be a digital assistant (PDA) or a wireless telephone with a display screen, or other “smart phone” type devices.

Computer network 100 may further comprises one or more second client computers 126. In many configurations, second client computer 126 is in communication with server computer 102 via network 113. Also in many configurations, second client computer 126 comprises a second client module comprising software instructions recorded on a machine-readable medium or media 128. In many configurations, second client computer 126 further comprises at least a readable and writable memory 130, ROM 132 and a processor 134 that may itself comprise one or more microprocessors, coprocessors, etc. Second client computer 126 may itself comprise one or more computers in a network. Second client computer 126 further comprises a second user display device 136, such as a CRT display, LCD display, plasma display, and/or a hardcopy device such as a printer. Second client computer 126 also comprises a second user input device 138, such as a keyboard, a mouse, a microphone for accepting voice commands, a touchscreen (which may be part of the display 136), and/or a trackball, etc.

As used herein, software instructions are said to “instruct the computer to display” information even if such information is communicated via a network to another computer for display on a remote display terminal. In this sense code running on a Web server instructs a processor executing that code to “display” a webpage, even though the code actually instructs the processor to communicate data via a network that allows a browser program to instruct in other computer to construct the display of the webpage on the display of the other computer. For example, the server module described in the examples presented herein can include a Web server and the client modules can comprise Web browsers. Also, in some configurations, client computers 112 and 126 comprise laptop, desktop, or mobile computing devices or communication terminals. The broader scope of the phrase “instruct the computer to display” is used because server computer 102 and the one or more client computers 112, 126 need not necessarily be different computers. For example, communication protocols known in the art allows server software module and a client software module running on multitasking computer systems to communicate with one another on the same computer system, and the same server software module can also communicate with a client software module running on a different computer via a network connection.

The terms “display” and “accept” as used in the description herein referred to a suitably programmed computing apparatus “displaying” or “accepting” data, not to a person “displaying” or “accepting” something. A person might, however view the display data on an output device on a page produced by an output device or supplied except the data using an input device.

Although the flow charts provided herein are illustrative of configurations methods used herein, it will be understood that the order of the steps shown to be buried from the order illustrated in other configurations of the present invention, that steps illustrated as being separate can be combined (e.g., various displays and request for data can be combined into a single output screen), and that not all steps illustrated are necessarily required in all configurations.

While particular embodiments of the present invention have been shown and described, it will be obvious to those skilled in the art that changes and modifications may be made without departing from this invention. Therefore, it is intended that the claims herein are to include all such obvious changes and modifications as fall within the true spirit and scope of this invention.

### REFERENCES

The teachings of the references cited herein are incorporated herein in their entirety:
Bicchi, A. (2000). Hands for dextrous manipulation and robust grasping: A difficult road toward simplicity. Transaction of Robotics and Automation, 16(6), 652-662.
Fitts, P. (1954). The information Capacity of the Human Motor System in Controlling the Amplitude of Movement. Journal of Experimental Psychology. 4(6), 381-391.
Schoneveld, K., Wittink, H., & Takken, R. (2009). Clinemetric evaluation of measurement tools used in hand therapy to assess activity and participation. Journal of Hand Therapy, 22, 221-236.
Vigouroux N., Vella F., Truillet P. & Raynal M. (2004) Evaluation of ACC for Text Input by Two Groups of Subjects: Able-bodied Subjects and Disabled Motor Subjects. 8th Proceedings of the ERCIM Workshop 2004.

I claim:

1. A method of evaluating the manual dexterity of a subject, the method comprising:
storing in computer readable memory associated with a manual dexterity evaluation system at least one test battery;
determining the subject's manual data-entry skill;
selecting, via a computer device associated with a manual dexterity evaluation system, at least one manual data-entry test from the at least one test battery based on the subject's manual data-entry skill;
instructing the subject on the test procedure;
providing via the manual dexterity evaluation system at least one means for inputting data;
collecting subject-specific data during the performance of the at least one test by the subject;
processing, via the computing device, the subject-specific data to generate at least one manual dexterity performance metric; and,
generating, via the computing device, an output including the at least one manual dexterity performance metric.

2. The method of claim 1, wherein the determining step comprises requesting that the subject respond to a series of questions relating to the subject's manual data-entry skill and using the subject's responses to develop a characterization of the subject's manual data-entry skill, said characterization being stored as data on computer readable medium.

3. The method of claim 1, wherein the determining step comprises retrieving the subject's manual dexterity data from computer readable medium.

4. The method of claim 1, wherein the determining step comprises retrieving the subject's manual dexterity data from a database.

5. The method of claim 1, wherein the at least one manual data-entry test assesses manual-dexterity as a function of the amount of time it takes the subject to complete the test and the number of data-entry errors committed by the subject during the performance of the test.

6. The method of claim 1, wherein the at least one manual data-entry test comprises requiring the subject to input the information displayed to the subject by the computer device by using at least one hand to input the information in the manual dexterity evaluation system using the means for inputting data.

7. The method of claim 6, wherein the information displayed comprises sentences of varying length and complexity.

8. The method of claim 1, wherein the means for inputting data is a telephone keypad.

9. The method of claim 1, wherein the means for inputting data is a soft keyboard.

10. The method of claim 1, wherein the instructing step comprises oral instructions relayed to the subject.

11. The method of claim 1, wherein the instructing step comprises written instructions relayed to the subject.

12. The method of claim 1, wherein the instructing step comprises instructional information generated and relayed to the subject via the computing device.

13. The method of claim 1, further comprising the step of transmitting the output to another device by means for communicating.

14. The method of claim 1, wherein the subject's responses are received by way of oral communication.

15. The method of claim 1, wherein the processing step comprises using statistical methods to calculate, via the computing device, a manual dexterity performance metric utilizing the stored data.

16. The method of claim 1, wherein the processing step comprises calculating a composite score as weighted by the subject's manual data-entry skill.

17. A device for measuring the manual dexterity of a subject comprising a central processing unit, a display, storage means, input means and software programming designed to gather the manual dexterity data of a subject; wherein the software programming is machine-readable medium or media having instructions recorded thereon that when executed by a processor:
determines the subject's manual data-entry skill;
performs at least one test of manual data-entry skill, the difficulty of the at least one test being based on the determination of the subject's manual data-entry skill;
collects, via input means, subject-specific data during the performance of the at least one test of manual data-entry skill;
calculates at least one manual dexterity performance metric weighted by the subject's manual data-entry skill;
generates an output that includes at least one manual dexterity performance metric;
stores the subject-specific data on the storage means.

18. The device of claim 17, wherein data stored on the storage means may be received from and transmitted to other devices by communication means.

19. The device of claim 17, wherein the software further comprises instructions for relaying the test procedure to the subject.

20. The device of claim 17, wherein the software further comprises instructions to determine the subject's manual-date entry skill by instructing that the subject respond to a series of questions relating to the subject's manual data-entry skill and using the subject's responses to develop a characterization of the subject's manual data-entry skill, said characterization being stored as data on computer readable medium.

21. The device of claim 17, wherein the software further comprises instructions to determine the subject's manual-date entry skill by retrieving the subject's manual dexterity data from computer readable medium.
